(19) United States
(12) Patent Application Publication
(10) Pub. No.: US 2019/0156611 A1
(43) Pub. Date: May 23, 2019

(54) DEVICE EXCHANGE AND DATA TRANSFER

(71) Applicant: DeviceTree, San Diego, CA (US)

(72) Inventors: Dean Redhead, San Diego, CA (US); Jonathan Long, Springdale, AR (US)

(21) Appl. No.: 16/192,596

(22) Filed: Nov. 15, 2018

Related U.S. Application Data
(60) Provisional application No. 62/588,213, filed on Nov. 17, 2017.

(51) Int. Cl. G07F 9/00; G06Q 20/18; G06K 19/14; G07F 7/06; G07F 17/00; G06K 7/14; G06T 7/00; G06T 17/00

(52) U.S. Cl. CPC G07F 9/006; G06Q 20/18; G06K 19/14; G06T 17/00; G07F 17/0014; G06K 7/1434; G06T 7/0002; G07F 7/06

(57) ABSTRACT

A kiosk for accomplishing device exchange and data transfer includes hardware and software for enabling users to submit a used or damaged device to the kiosk, downloading user information and settings from the submitted device, converting the downloaded user information and settings into an appropriate format for a purchased device, and uploading the converted user information and settings to the purchased device before delivering the purchased device to the user.

### RELATED APPLICATIONS

This application claims the benefit of U.S. Provisional Patent Application No. 62/588,213, filed on Nov. 17, 2017 and entitled “DEVICE EXCHANGE AND DATA TRANSFER,” which is incorporated herein by reference in its entirety.

### FIELD OF THE INVENTION

The present disclosure generally relates to the field of devices, and more particularly to the field of providing automated device exchange and data transfer services.

### BACKGROUND OF THE INVENTION

Generally speaking, the device industry suffers from a poor reputation for slow service, high repair costs, unscrupulous and/or unqualified technicians performing low quality services, the use of inferior repair parts, and refusal to offer guarantees on repairs. For device users that have or have purchased an insurance protection product, the user is typically without his or her device for a minimum of three days while the insurance provider processes the user's claim. On top of that, users often lose data, apps, and other on-device information in the device exchange process. Further, customers are often unable to obtain a protection plan or other insurance coverage on their used or out-of-contract devices.

### SUMMARY OF THE INVENTION

The issues identified above can be addressed by providing a convenient kiosk running specialized software that can perform device “repair exchange” and supply consumers with new and refurbished unlocked devices, device accessories, device protection plans, and SIM cards.

A kiosk according to the present disclosure is fully automated, and provides numerous services. Using the kiosk's repair exchange service, customers can exchange a damaged device for a new device or a certified refurbished device. The kiosk retrieves all of the customer's data—including but not limited to contacts, photos, movies, text messages, mobile web applications, apps, usage and/or browsing histories, call logs, voicemails, emails, settings, and device identification numbers—from the damaged device and copies the data to the new or certified refurbished device before providing the new or certified refurbished device to the customer.

Kiosks according to embodiments of the present disclosure also allow consumers to purchase refurbished, unlocked smart devices for use with all carriers. Consumers can also upgrade a used device by exchanging the used device for a new or refurbished device. Additionally or alternatively, consumers can purchase new, OEM factory unlocked smart devices for use with all carriers.

Beyond allowing consumers to purchase or upgrade devices, a kiosk according to embodiments of the present disclosure may allow customers to purchase new certified device accessories, including but not limited to data cords, wall chargers, car chargers, phone cases, and tempered glass screen protectors. The kiosk may also allow customers to purchase and activate cellular SIM cards for a new or refurbished device purchased from the kiosk or for their own existing device. Customers may be able to turn in a used or damaged device for credit towards a kiosk purchase. And, customers may be able to purchase protection/repair contracts from the kiosk, which in some embodiments may provide a monetary incentive to encourage customers to utilize the kiosk for future repair exchanges or other services.

In some embodiments, the kiosk may be configured to receive and store used or damaged devices that cannot be immediately and/or automatically repaired and/or replaced by the kiosk (whether due to insufficient inventory or otherwise). Such devices may be retrieved by an owner or operator of the kiosk or by another authorized entity and taken off-site for repair and/or exchange. Repaired or other devices may then be mailed to the appropriate customer or returned to the kiosk for pickup by the appropriate customer.

According to one embodiment of the present disclosure, a kiosk comprises: a device intake alcove; a device delivery alcove; an automated storage center storing a plurality of inventory items and comprising an automated system for selectively retrieving a selected one of the plurality of inventory items; a user interface comprising a display screen and a user input device; a payment center; a processor; and a memory. The memory stores instructions for execution by the processor that, when executed by the processor, cause the processor to: download user information from a submitted device positioned in the device intake alcove; cause the automated system to retrieve a selected device from the plurality of inventory items; upload the user information to the selected device; and cause the automated system to place the selected device in the device delivery alcove.

The device intake alcove may comprise a 3D scanner, and the memory may store additional instructions for execution by the processor that, when executed by the processor, cause the processor to: cause the 3D scanner to scan the submitted device and generate a 3D image of the submitted device; analyze the 3D image of the submitted device; and identify, based on the analysis, physical damage to the submitted device. The device intake alcove may comprise a device connector, and the memory may store additional instructions for execution by the processor that, when executed by the processor, cause the processor to: cause the display screen to display instructions for connecting the device connector to the submitted device; and electronically scan the submitted device to obtain device information about the submitted device.

The device information may comprise an identification number of the device, and the memory may store additional instructions for execution by the processor that, when executed by the processor, cause the processor to: access, via a communication interface, a database of device identification numbers; search the database using the identification number of the device to obtain search results; and determine, based on the search results, whether the submitted device is blacklisted or stolen.

The memory may store device inventory information comprising information about a plurality of devices available for purchase or exchange from the kiosk; and the memory may store additional instructions for execution by the processor that, when executed by the processor, cause the processor to: cause the display screen to display at least some of the device inventory information; and receive, via the user input device, a signal identifying one of the plurality of devices selected for purchase or exchange by a user of the kiosk.

The memory may store accessory inventory information comprising information about a plurality of accessories available for purchase from the kiosk. The memory may also store additional instructions for execution by the processor that, when executed by the processor, cause the processor to: cause the display screen to display at least some of the accessory inventory information; and cause the display screen to solicit a user selection related to the displayed accessory inventory information.

The memory may store terms and conditions of at least one protection plan available for purchase from the kiosk. The memory may store additional instructions for execution by the processor that, when executed by the processor, cause the processor to: cause the display screen to display the terms and conditions of at least one protection plan available for purchase from the kiosk; and cause the display screen to solicit a user selection related to the displayed terms and conditions.

The memory may store additional instructions for execution by the processor that, when executed by the processor, cause the processor to: transmit a signal to the payment center, the signal corresponding to an amount of money to be collected from a user; and receive a confirmation signal from the payment center, the confirmation signal indicating that the amount of money has been collected. The user interface may be a touchscreen. The kiosk may further comprise a communication interface that enables a user of the kiosk to send and receive live communications from the user interface.

According to another embodiment of the present disclosure, a device exchange and data transfer kiosk comprises an automated storage center for storing an inventory comprising multiple items, the automated storage center comprising an automated system for selectively retrieving a selected inventory item from among the multiple items in inventory; a user interface comprising a touchscreen; a payment center; a wireless transceiver; a processor; a device intake module, the device intake module comprising at least one of a 3D scanner and a device connector; and a device configuration module comprising instructions for execution by the processor. The instructions, when executed by the processor, cause the processor to: obtain data and information from a first device; and configure a second device based on the obtained data and information.

The first device may utilize a different operating system than the second device. The configuring may comprise converting at least some of the obtained data and information from a first format into a second format. The obtained data and information may comprise at least one of user contacts, user photos, movies, text messages, mobile web applications, apps, call logs, voicemails, emails, usage histories, browsing histories, and settings. The obtaining and configuring may be completed in ten minutes or less.

According to yet another embodiment of the present disclosure, a kiosk for exchanging devices comprises: a storage area comprising an inventory of devices; a touchscreen user interface configured to display information about products and services available through the kiosk and to receive user selections; a device intake alcove; a device intake module comprising an imaging device; a processor; a communication interface for establishing electronic communications between the processor and a submitted device; a device configuration module for configuring a purchased device; and a device delivery alcove.

The device intake module may further comprise instructions for execution by the processor that, when executed by the processor, cause the processor to: cause the touchscreen user interface to display instructions for placing the submitted device into the device intake alcove; cause the imaging device to capture an image of the submitted device; analyze the image; and based on the analysis, identify physical damage to the submitted device.

The device intake module may further comprise instructions for execution by the processor that, when executed by the processor, cause the processor to: cause the touchscreen user interface to display instructions for establishing a communication channel between the submitted device and the processor; obtain a unique device identification number corresponding to the submitted device via the communication channel; download user information from the submitted device; and cause the user information on the submitted device to be erased.

The device configuration module may further comprise instructions for execution by the processor that, when executed by the processor, cause the processor to upload the user information to a purchased device from among the inventory of devices.

The terms “memory” and “computer-readable storage medium” are used interchangeably and, as used herein, refer to any tangible storage and/or transmission medium that participate in providing instructions to a processor for execution. Such a medium may take many forms, including but not limited to non-volatile media, volatile media, and transmission media. Non-volatile media includes, for example, NVRAM, or magnetic or optical disks. Volatile media includes dynamic memory, such as main memory. Common forms of computer-readable media include, for example, a floppy disk, a flexible disk, hard disk, magnetic tape, or any other magnetic medium, magneto-optical medium, a CD-ROM, any other optical medium, punch cards, paper tape, any other physical medium with patterns of holes, a RAM, a PROM, and EPROM, a FLASH-EPROM, a solid state medium like a memory card, any other memory chip or cartridge, a carrier wave as described hereinafter, or any other medium from which a computer can read. A digital file attachment to e-mail or other self-contained information archive or set of archives is considered a distribution medium equivalent to a tangible storage medium. When the computer-readable medium is configured as a database, it is to be understood that the database may be any type of database, such as relational, hierarchical, object-oriented, and/or the like. Accordingly, the disclosure is considered to include a tangible storage medium or distribution medium and prior art-recognized equivalents and successor media, in which the software implementations of the present disclosure are stored.

The phrases “at least one,” “one or more,” and “and/or,” as used herein, are open-ended expressions that are both conjunctive and disjunctive in operation. For example, each of the expressions “at least one of A, B and C,” “at least one of A, B, or C,” “one or more of A, B, and C,” “one or more of A, B, or C,” and “A, B, and/or C” means A alone, B alone, C alone, A and B together, A and C together, B and C together, or A, B and C together.

Unless otherwise indicated, all numbers expressing quantities, dimensions, conditions, and so forth used in the specification and claims are to be understood as being modified in all instances by the term “about.”

The term “a” or “an” entity, as used herein, refers to one or more of that entity. As such, the terms “a” (or “an”), “one or more” and “at least one” can be used interchangeably herein.

The use of “including,” “comprising,” or “having” and variations thereof herein is meant to encompass the items listed thereafter and equivalents thereof as well as additional items. Accordingly, the terms “including,” “comprising,” or “having” and variations thereof can be used interchangeably herein.

It shall be understood that the term “means” as used herein shall be given its broadest possible interpretation in accordance with 35 U.S.C. Section 112(f). Accordingly, a claim incorporating the term “means” shall cover all structures, materials, or acts set forth herein, and all of the equivalents thereof. Further, the structures, materials, or acts and the equivalents thereof shall include all those described in the summary of the invention, brief description of the drawings, detailed description, abstract, and claims themselves.

These and other advantages will be apparent from the disclosure of the invention(s) contained herein. The above-described embodiments, objectives, and configurations are neither complete nor exhaustive. The Summary of the Invention is neither intended nor should it be construed as being representative of the full extent and scope of the present invention. Moreover, references made herein to “the present invention” or aspects thereof should be understood to mean certain embodiments of the present invention and should not necessarily be construed as limiting all embodiments to a particular description. The present invention is set forth in various levels of detail in the Summary of the Invention as well as in the attached drawings and the Detailed Description and no limitation as to the scope of the present invention is intended by either the inclusion or non-inclusion of elements, components, etc. in this Summary of the Invention. Additional aspects of the present invention will become more readily apparent from the Detailed Description, particularly when taken together with the drawings.

### BRIEF DESCRIPTION OF THE DRAWINGS

The accompanying drawings are incorporated into and form a part of the specification to illustrate several examples of the present disclosure. These drawings, together with the description, explain the principles of the disclosure. The drawings simply illustrate preferred and alternative examples of how the disclosure can be made and used and are not to be construed as limiting the disclosure to only the illustrated and described examples. Further features and advantages will become apparent from the following, more detailed description of the various aspects, embodiments, and configurations of the disclosure, as illustrated by the drawings referenced below.

FIG. 1A shows a kiosk according to one embodiment of the present disclosure;

FIG. 1B shows a block diagram of a kiosk according to the embodiment of FIG. 1A;

FIG. 2 is a flowchart of a process according to another embodiment of the present disclosure;

FIG. 3 is a flowchart of a process according to yet another embodiment of the present disclosure;

FIG. 4 is a flowchart of a process according to still another embodiment of the present disclosure; and

FIG. 5 is a flowchart of a process according to a further embodiment of the present disclosure.

### DETAILED DESCRIPTION

Before any embodiments of the present disclosure are explained in detail, it is to be understood that the disclosure is not limited in its application to the details of construction and the arrangement of components set forth in the following description or illustrated in the drawings. The disclosure is capable of other embodiments and of being practiced or of being carried out in various ways. Also, it is to be understood that the phraseology and terminology used herein is for the purpose of description and should not be regarded as limiting. The use of “including,” “comprising,” or “having” and variations thereof herein is meant to encompass the items listed thereafter and equivalents thereof as well as additional items. Further, the present disclosure may use examples to illustrate one or more aspects thereof. Unless explicitly stated otherwise, the use or listing of one or more examples (which may be denoted by “for example,” “by way of example,” “e.g.,” “such as,” or similar language) is not intended to and does not limit the scope of the present disclosure.

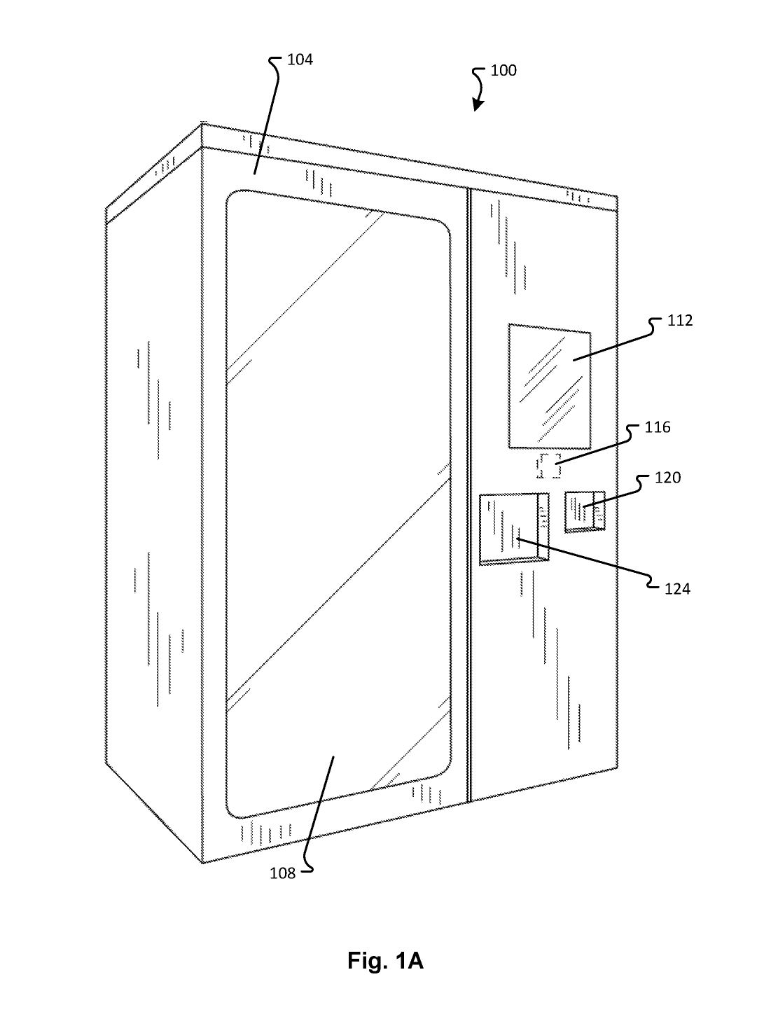

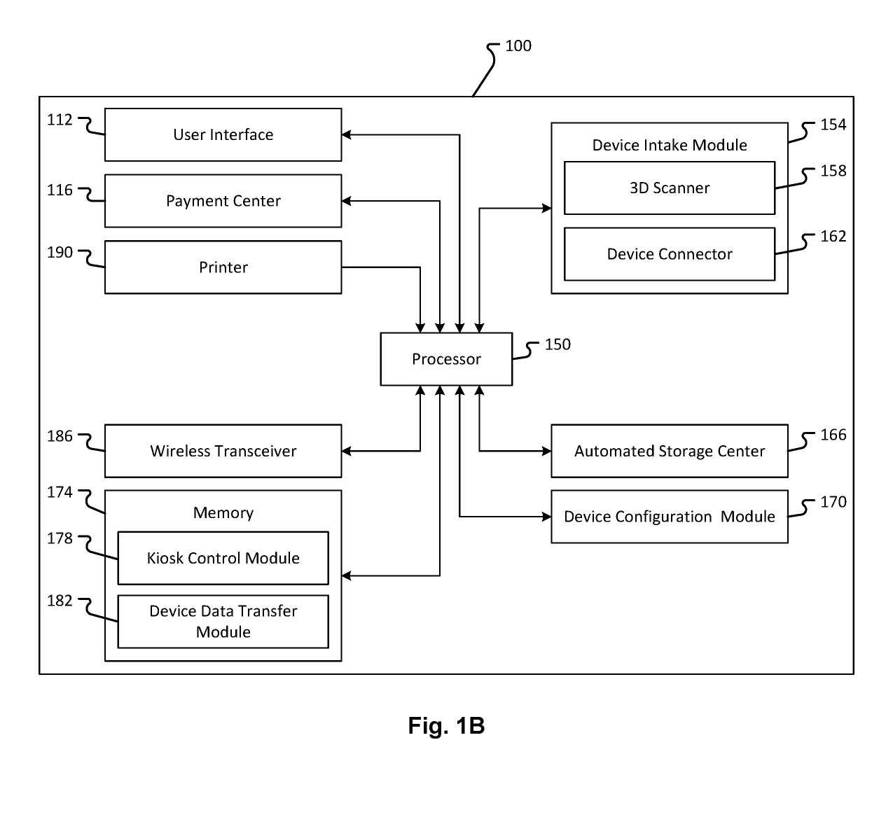

With reference now to FIG. 1A, a kiosk 100 according to embodiments of the present disclosure comprises a tower 104, a window 108, a user interface 112, a payment center 116, a device delivery alcove 120, and a device intake alcove 124.

The tower 104 provides the structure that supports, contains, and protects the various elements and inventory of the kiosk. The tower 104 may comprise an internal frame manufactured in whole or in part of steel, aluminum, or another metal. The tower 104 may also comprise an external shell secured to the frame and manufactured from metal, composite materials, and/or plastic. As shown in FIG. 1A, the tower 104 comprises one or more heavy-duty windows 108 through which a portion of the interior of the tower 104 may be seen. The visible portion of the interior of the tower 104 may be used, for example, as a display case for the devices and device accessories that may be purchased from the kiosk 100. The one or more heavy-duty windows 108 may be made of glass or plastic, and may be designed to withstand significant forces imposed thereon so as to reduce the likelihood that the contents of the kiosk can be accessed (and thus stolen or damaged) by breaking the heavy-duty window 108.

The tower 104 also comprises one or more access panels (not shown), through which kiosk inventory can be replenished or replaced, collected devices can be removed, and kiosk components can be serviced. The access panels are provided with access control features appropriate for the high value of the devices and accessories stored within the kiosk 100. For example, the access panels may be fitted with one or more padlocks, and may be designed to prevent the opening thereof prior to removal of the one or more padlocks.

The tower 104 supports a user interface 112, which may be used to display information about the services available through the kiosk 100 to a user or consumer, as well as to receive input from the user or consumer in connection with such services. The user interface 112 may comprise one or more user input devices and one or more output devices. For example, the user interface 112 may comprise a keyboard, a mouse/trackball, one or more buttons, and/or a microphone, as well as a display for displaying information to a user and/or a speaker for audible communications with a user. The display may be any type of screen known in the art that is suitable for converting electronic signals into a visual representation for display to a user. The display may be or comprise, for example, one or more of a cathode ray tube display, a light-emitting diode display, a plasma display panel, a liquid crystal display, and/or an organic light-emitting diode display. In some embodiments, the one or more user input devices and the one or more output devices may be combined into a single device. For example, the user interface 112 may comprise a touchscreen, which may be any type of touchscreen known in the art. For example, the touchscreen may be or comprise a 5-wire resistive touchscreen, a surface capacitive touchscreen, a projected capacitive touchscreen, a surface acoustic wave touchscreen, and/or an infrared touchscreen.

The payment center 116 may be or comprise a device—including any necessary hardware and software—for accepting payment from a user of the kiosk 100. For example, the payment center 116 may be or comprise a credit card machine capable of reading a user's credit or debit card, establishing communication with the issuer of the credit or debit card (via, e.g., a wired or wireless connection), and charging the card for the amount of a transaction agreed upon by the user. In some embodiments, the payment center 116 may additionally or alternative comprise the necessary hardware and software for receiving cash payments, and, in some embodiments, for returning to the user an amount of money equal to the difference between the amount paid by the user and the amount charged by the kiosk 100 (where the user has paid more than the amount due). In other embodiments, the kiosk 100 and/or the payment center 116 may be configured to provide a credit toward future purchases at the kiosk 100 to a user that overpays for a given item or service from the kiosk 100. Such embodiments beneficially avoid the need to maintain an inventory of cash for providing change to a user.

The device delivery alcove 120 provides a space into which the kiosk 100 (or, more specifically, an automated system within the kiosk 100) can deposit a purchased new or refurbished device and/or any purchased accessories for retrieval by a user. In some embodiments, an interior surface of the device delivery alcove 120 may comprise a door, flap, gate, trapdoor, or other mechanism that can be selectively opened by the kiosk 100 to deposit any purchased items into the device delivery alcove 120, and subsequently securely closed to prevent a malicious attempt to access the interior of the kiosk 100 via the device delivery alcove 120. In other embodiments, the kiosk 100 may deposit purchased items into the device delivery alcove 120 through a channel, flume, or other passageway that is designed to allow items sold by the kiosk to pass therethrough to be deposited in the device delivery alcove 120, but to prevent a human hand or arm or a mechanical substitute or equivalent thereof from accessing the interior of the kiosk 100 through the device delivery alcove 120.

In some embodiments the device delivery alcove 120 may also comprise a door, gate, flap, or other closure mechanism that, when closed, constitutes a barrier between the device delivery alcove 120 and the exterior of the kiosk 100. The door, gate, flap, or other closure mechanism may be selectively openable by a user and/or by the kiosk 100 (e.g. using an appropriate mechanism that can be controlled automatically), so as to permit access to the interior of the device delivery alcove 120 (e.g., once one or more purchased items have been deposited therein). The door, gate, flap, or other closure mechanism may be lockable to ensure that the device delivery alcove 120 is only accessible when one or more purchased items have been deposited therein. The door, gate, flap, or other closure mechanism may be useful for ensuring that items deposited in the device delivery alcove 120 do not fall out of the device delivery alcove 120 when delivered to the device delivery alcove 120, and may also be useful for enhancing the security of the device delivery alcove 120. In some embodiments, the door, gate, flap, or other closure mechanism may be transparent, so that the contents of the device delivery alcove 120 may be seen. In other embodiments, the door, gate, flap, or other closure mechanism may be opaque, so as to prevent the contents of the device delivery alcove 120 from being seen.

The device intake alcove 124 provides a space into which a user can place a device that the user wishes to exchange or have repaired. The device intake alcove 124 may comprise one or more devices for gathering information from and/or about a user's device. For example, the device intake alcove 124 may comprise a 3D scanner capable of generating an accurate 3D scan of the device, which may in turn be used by the kiosk 100 (or, more specifically, by a processor of the kiosk 100) to identify the device (e.g. by comparing the 3D scan to known information about the dimensions and contours of a plurality of devices, which information may be stored, for example, in a database in a memory of the kiosk 100, which memory and database are accessible to a processor of the kiosk 100). The 3D scan may also be used to determine whether the screen of the submitted device is cracked, and/or to identify other physical damage to the device.

The device intake alcove 124 may also comprise a plurality of connectors for establishing a wired connection between the kiosk 100 and a submitted device. In some embodiments, a user may be required to insert an appropriate connector into the submitted device, while in other embodiments, the device intake alcove 124 may comprise one or more robotic mechanisms for automatically inserting an appropriate connector into a port of the device. In such embodiments, the one or more robotic mechanisms may utilize information from the 3D scan to determine a location of a port of the submitted device, and also to identify the type of connector needed based on the shape of the port. Where one or more robotic mechanisms are used, the one or more robotic mechanisms may maneuver a connector into position without moving the device, or the one or more robotic mechanisms may maneuver the device into position without moving the connector, or the one or more robotic mechanism may maneuver both the device and the connector into a position where the connector can be inserted into the device.

Once a wired connection is established between the device and the kiosk 100, a processor of the kiosk 100 may communicate with the device to download information from the device and/or to upload information to the device.

In some embodiments, the kiosk 100 may comprise a wireless router, and the user interface 112 may provide instructions to a user for establishing a connection between the user's device and the wireless router. In such embodiments, information may be downloaded from and/or uploaded to a user's device via a wireless connection rather than via a wired connection.

Turning now to FIG. 1B, a block diagram of a kiosk 100 illustrates additional components of the kiosk 100. More specifically, the kiosk 100 comprises, in addition to a user interface 112 and a payment center 116, a processor 150; a device intake module 154 (comprising a 3D scanner 158 and a device connector 162); an automated storage center 166; a device configuration module 170; a memory 174 (comprising a kiosk control module 178 and a device data transfer module 182); a wireless transceiver 186; and a printer 190.

The processor 150 may correspond to one or multiple microprocessors that are contained within a housing of the kiosk 100. The processor 150 may comprise a Central Processing Unit (CPU) on a single Integrated Circuit (IC) or a few IC chips. The processor 150 may be a multipurpose, programmable device that accepts digital data as input, processes the digital data according to instructions stored in its internal memory, and provides results as output. The processor 150 may implement sequential digital logic, as it has internal memory. As with most known microprocessors, the processor 150 may operate on numbers and symbols represented in the binary numeral system. The processor 150 may execute instructions stored in a firmware thereof, and may also execute instructions stored in the memory 174. The processor 150 may be used to control one or more aspects of the other components of the kiosk 100. The processor 150 may also be used to read data from or to write data to the memory 174, and may be configured to execute instructions stored within the memory 174.

The user interface 112 and the payment center 116 were described previously with respect to FIG. 1A. Each sends and/or receives signals from the processor 150 so as to enable proper functioning of the kiosk 100. For example, the user interface 112 receives signals from the processor 150 that cause the user interface 112 to display appropriate information to a user of the kiosk 100, and the processor 150 receives signals from the user interface 112 corresponding to input received from the user. Similarly, the processor 150 sends signals to the payment center 116 that, for example, contain or correspond to the amount to be collected from a user of the kiosk 100, and the payment center 116 sends signals to the processor 150 regarding the status of the user's payment (e.g., whether the payment has been received or not).

In some embodiments, the user interface 112 may transmit a wake-up signal to the processor 150 in response to an input from a user of the kiosk 100 through the user interface 112 that causes the processor 150 to switch from an inactive state to an active state. Similarly, in some embodiments, the processor 150 may send one or more signals to the payment center 116 to activate the payment center 116 when a payment is to be made, and the payment center 116 may otherwise remain in an inactive state.

The device intake module 154 comprises hardware and/or software for conducting a physical and an electronic evaluation of a device provided by a user of the kiosk 100. The device intake module 154 may include, for example, a 3D scanner 158, which may be used to generate a 3D image or model of a submitted device. The 3D image or model may then be used to identify the device model, to detect physical damage to the device, and in some embodiments to determine an orientation of the device. By using the 3D image or model to identify the device model and to detect physical damage to the device, information provided by the user via the user interface 112 about the model type and physical condition of the device can be corroborated or shown to be incorrect. Alternatively, the 3D image or model may be used so that a user does not have to input information about the device type and/or the physical condition of the device.

In embodiments where the 3D image or model is used to determine an orientation of the device, the orientation may be used to identify a location of a port of the device, and/or to determine how to position a robotic hand or other mechanism to pick up the device (e.g. to transport the device from a device intake alcove 124 to a storage location inside of the kiosk 100.

The device intake module 154 further comprises one or more device connectors 162. The device intake module 154 may comprise, for example, a device connector 162 for each type of device serviceable by the kiosk 100. Thus, for example, if the kiosk 100 is configured to service devices from a plurality of manufacturers, and each of the plurality of manufacturers uses a specific device connector 162 for all of its devices, then the device intake module 154 may comprise one of each of the specific device connectors 162 for each of the plurality of manufacturers. In this way, a device connector 162 is available for any submitted device, provided that the submitted device is of a type that is serviceable by the kiosk 100.

The device connector 162 may be provided on a cable or wire that extends into the device intake alcove 124 of the kiosk 100, so that a user who places a device into the device intake alcove 124 can manually connect the device connector 162 to the device. In some embodiments, the device connector 162 may be provided in a fixed position on or within the device delivery alcove, and the user may manually position the device so that the device connector 162 is positioned within a port of the device. In still other embodiments, the device connector 162 may be positioned automatically by a robotic hand or other mechanism that uses, for example, the 3D image or model obtained using the 3D scanner 158 to determine the location of a port on the device, so as to be able to maneuver the device connector 162 into position and insert the device connector 162 into the port of the device. In some embodiments, the device may be connected automatically from the user.

Once the device connector 162 is connected to a port of a submitted device, the processor 150 can utilize the connection with the device to, for example, verify that the electronic systems of the device 100 are in working order; determine the operating system version presently installed on the device; determine the specifications of the device (e.g. how much memory is included within the device, the speed of the processor of the device, the condition of the battery of the device); and/or download information from the device. Particularly where a user wishes to exchange a used device for a new or refurbished certified device, the processor 150 may utilize the connection with the device via the device connector 162 to download user information from the device, including but not limited to the user's contacts, photos, movies, text messages, mobile web applications, apps, usage and/or browsing histories, call logs, voicemails, emails, settings, and device identification numbers. The processor 150 may also erase or delete all such information from the device after the information has been downloaded or otherwise copied, so that, for example, the device can be refurbished and sold to a third party without compromising any personal information of the user that submitted the device to the kiosk 100.

In some embodiments, the processor 150 may utilize the information obtained from the device intake module 154, including from the 3D scanner 158 and the device connector 162, to make a determination regarding the value of a submitted device, and/or regarding the cost of repairing the submitted device, if damaged. Information corresponding to one or both of these determinations may be displayed to the user that submitted the device via the user interface 112. For example, the processor 150 may cause the user interface 112 to display to the user an amount of credit that the user would receive toward a new or refurbished device from the kiosk 100 for submitting the user's current device for exchange. Additionally or alternatively, the processor 150 may cause the user interface 112 to display to the user a quote for repairing the user's damaged device, which may take into account the expected actual cost of repair as well as a predetermined amount of markup.

The information obtained from the device intake module 154 may also be used to determine which accessories to offer to a user that does not wish to exchange his or her device. For example, once the kiosk 100 determines the user's device type (e.g. brand and model), the processor 150 may cause the user interface 112 to display accessories available for purchase that are compatible with the user's device. The processor 150 may also provide a quote for a protection plan for the device, which quote may be based upon a determination regarding the value of the device.

The automated storage center 166 comprises a physical storage space as well as hardware and software necessary to manage the inventory of the physical storage space. For example, the physical storage space may hold an inventory of devices (the devices representing a plurality of brands and/or models) and device accessories (e.g. wall chargers, car chargers, connecting wires, headphones, earbuds, camera attachments, device cases, device screen protectors). The automated storage center 166 comprises an automated system (which may comprise hardware and software) configured to retrieve a selected item from this inventory based on instructions received from the processor 150, and to deposit the selected item in the device delivery alcove 120. The automated system may comprise, for example, one or more robotic arms for picking up an item from a storage or display location and moving it to the device delivery alcove 120 (or another desired location). Additionally or alternatively, the automated system may comprise a series of movable storage modules that can be moved by appropriate mechanical systems in one, two, or three dimensions so as to transport an item kept within a storage module from a storage or display location to a delivery location. Additionally or alternatively, the hardware may comprise one or more conveyor belts. Additionally or alternatively, the hardware may comprise an elevator capable of moving in one or two dimensions (e.g., vertically and laterally) and that can therefore be positioned in front of a given storage row to receive an item that is pushed off of the storage row and onto the elevator by mechanical or other means, and that can then carry the item to the device delivery alcove 120 or to another desired location. This or other hardware may be controlled by the processor 150 or another processor executing instructions stored in a memory of the automated system, or in the memory 174, or in another memory.

The device configuration module 170 comprises hardware and/or software needed to configure a new or refurbished device that has been purchased by a user of the kiosk 100, prior to delivering the new or refurbished device to the user. In some embodiments, the device configuration module 170 may comprise one or more device connectors, separate from the device connector(s) 162, that may be manually or automatically plugged into a new or refurbished device, so as to establish electrical communication between the new or refurbished device and the processor 150. Once such communication is established, the processor 150 may cause user information obtained from a user's submitted device (including, for example, the user's contacts, photos, movies, text messages, mobile web applications, apps, usage and/or browsing histories, call logs, voicemails, emails, settings, and device identification numbers) to be copied onto the new or refurbished device, so that the user can immediately begin using the new or refurbished device. In some embodiments, the device configuration module 170 is configured to convert user information received in a format compatible with a first operating system (e.g. an iOS operating system) into a format that is compatible with a second operating system (e.g. an Android operating system), so that a user of the kiosk 100 is not limited to exchanging a current or damaged device for a new or refurbished device having the same operating system. In some embodiments, the device configuration module 170 may be configured to accomplish the conversion in less than 10 minutes, or in less than 8 minutes, or in less than 7 minutes, or in less than 5 minutes, or in less than 3 minutes. Also in some embodiments, the device configuration module 170 may comprise or have access to a plurality of processors to reduce the time needed to accomplish the conversion.

The memory 174 comprises, for example, a kiosk control module 178 and a device data transfer module 182. The memory 174 may be used to store any electronic data needed for operation of the kiosk 100. For example, the memory 174 stores any drivers and firmware needed for allowing the processor 150 to operate and/or communicate with the various components of the kiosk 100, as needed. The memory 174 may also be used for data storage, including to store information about the products and/or services offered by the kiosk 100, the inventory of the kiosk 100, and information downloaded from a user-submitted device (at least until the information is uploaded to a new or refurbished device). The memory 174 may correspond to any type of non-transitory computer-readable medium. In some embodiments, the memory 174 may comprise volatile or non-volatile memory and a controller for the same. Non-limiting examples of memory 174 that may be utilized in the kiosk 100 include RAM, ROM, buffer memory, flash memory, solid-state memory, or variants thereof.

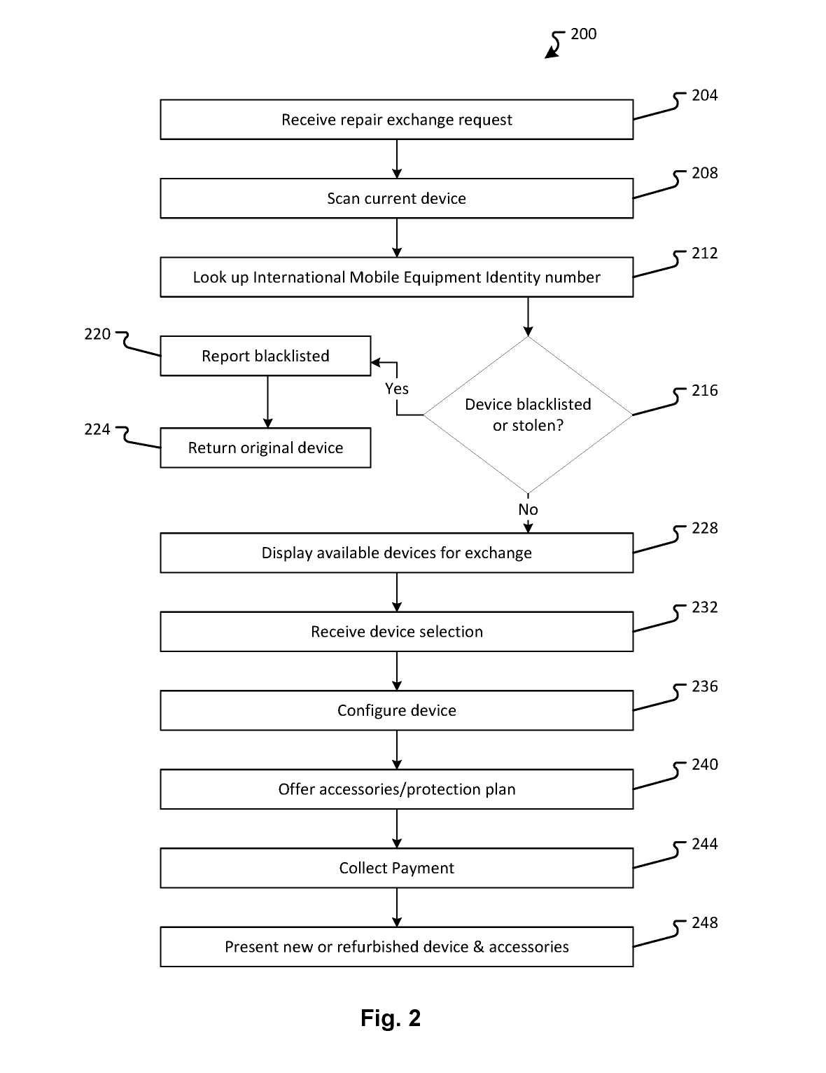

The kiosk control module 178 comprises instructions for execution by the processor 150 that, when executed, cause the processor 150 to carry out the various functions needed for proper operation of the kiosk 100. For example, the instructions may correspond to one or more of the processes described herein with respect to FIGS. 2-5. The instructions may be configured to cause the processor 150 to, for example, receive a signal from the user interface 112 indicating that someone would like to use the kiosk 100, or indicating that someone would like to purchase a product or service from the kiosk 100; transmit one or more signals to the user interface 112 that cause the user interface 112 to display information about the products and services available through the kiosk 100; receive a signal from the user interface 112 corresponding to a user selection of a particular product or service; transmit one or more signals from the user interface 112 that cause the user interface 112 to display additional information about the selected product or service; receive one or more additional signals from the user interface 112 corresponding to user preferences for a selected product or service; transmit one or more signals to the payment center 116, the automated storage center 166, the device intake module 154, the device configuration module 170, and/or one or more other components of the kiosk 100 to collect payment from the user of the kiosk 100 and to provide the desired product or service to the user of the kiosk 100; and transmit one or more signals to the printer 190 that cause the printer 190 to print a receipt for the product(s) or service(s) provided by the kiosk 100 to the user (or, alternatively, to cause an electronic receipt to be sent in an email or other electronic message to an email address or other online destination corresponding to the user, based on input from the user of the kiosk 100.

The memory 174 may also comprise a device data transfer module 182. The device data transfer module 182 may comprise instructions for execution by the processor that, when executed by the processor 150, cause the processor to convert data received in a first format from a user-submitted device via the device intake module 154 into a second format that is compatible with a new or refurbished device purchased by the user of the kiosk 100, so that the data can be loaded onto the new or refurbished device by the device configuration module 170 prior to delivery of the new or refurbished device to the user. The data transfer module 182 may also comprise instructions for causing the processor 150 to store information received from a user-submitted device (including, for example, contacts, photos, movies, text messages, mobile web applications, apps, usage and/or browsing histories, call logs, voicemails, emails, settings, and device identification numbers), and to copy the same information onto a new or refurbished device purchased by the user from the kiosk 100. The device data transfer module 182 may further comprise instructions for execution by the processor 150 that, when executed, cause the processor 150 to delete such information from the memory 174 or other computer-readable storage of the kiosk 100 after the information has been copied to the new or refurbished device purchased by the user, for example for data privacy purposes.

Although the kiosk control module 178 and the device data transfer module 182 are shown in FIG. 1B within the memory 174, each of the kiosk control module 178 and the device data transfer module 182 may be separate from the memory 174 and may comprise a dedicated memory. Similarly, although the device configuration module 170 and the device intake module 154 are shown as stand-alone components of the kiosk 100 in FIG. 1B, in some embodiments the software portions of the device configuration module 170 and of the device intake module 154 may be stored within the memory 174. Further, the functionality of the device data transfer module 182 may be provided instead in the device configuration module 170, or vice versa. Indeed, the present disclosure is not limited to the physical structure shown in FIGS. 1A and 1B, as various functions performed by the components identified in FIGS. 1A and 1B may be included in and/or provided by others of the components identified in FIGS. 1A and 1B or in other components altogether.

The wireless transceiver 186 comprises hardware that allows the kiosk 100 to connect with an available wireless network for wireless communications. The wireless transceiver 186 may comprise a Wi-Fi card, a Network Interface Card (NIC), a cellular interface (e.g., antenna, filters, and associated circuitry), an NFC interface, an RFID interface, a ZigBee interface, a FeliCa interface, a MiWi interface, a Bluetooth interface, a BLE interface, or the like. The wireless transceiver 186 may comprise, for example, a transmitter, a receiver, and an antenna, and may comprise software or firmware needed to operate such components.

The wireless transceiver 186 may be used, for example, in connection with the payment center 116 to establish a connection with a credit card company, bank, or other financial institution to verify payment information submitted by a user and/or to inform the financial institution of the user's transaction with the kiosk 100. The wireless transceiver 186 may also be used to communicate information about the current status of the kiosk 100 with a central server. For example, the wireless transceiver 186 may transmit information to a central server regarding any transaction completed at the kiosk 100, the current status of the inventory of the kiosk 100, and/or whether any user-submitted devices need to be picked up for repair or refurbishment. The wireless transceiver 186 may also receive information from a central server, including updated pricing information, information about promotions to be offered to users of the kiosk 100 via the user interface 112, and/or software updates. In some embodiments, the wireless transceiver 186 may enable a user of the kiosk 100 to engage in real-time communications with a technical support specialist, sales associate, or other live assistant via the user interface 112, whether using an instant messaging protocol, an email protocol, a Voice-over-IP protocol, a video-conferencing protocol, a cellular protocol, or any other protocol suitable for real-time communications.

The kiosk 100 may, in some embodiments, comprise a printer 190. The printer 190 may be used, for example, to print receipts at the conclusion of a transaction with a user of the kiosk 100. The receipts may be, for example, receipts for payments made by users, and/or receipts for devices submitted by users. The printer 190 may also be used to print the terms and conditions of any protection plans purchased by a user, and/or to print other information for a user about products and/or services offered by the kiosk 100. The printer may be any known or yet-to-be-discovered type of printer, including an inkjet printer, a laser printer, or a thermal printer.

Referring now to FIG. 2, a method 200 of operating a kiosk according to one embodiment of the present disclosure comprises receiving, at a processor (such as the processor 150), a repair exchange request (step 204). The repair exchange request may be received, for example, from a user interface such as the user interface 112. The repair exchange request may comprise or correspond to a selection, by a user of the kiosk, of a repair exchange service from among a list of products and services available through the kiosk, which list may be displayed to the user via the user interface. The repair exchange request may additionally or alternatively comprise information about repairs needed to a user's device, and/or about a new or refurbished device for which a user would like to exchange his or her current device. In some embodiments, the processor may, in response to receipt of the repair exchange request, cause a user interface of the kiosk to display, to a user (e.g. via a user interface), instructions for placing the user's current device in a device intake alcove, such as the device intake alcove 124. The instructions may also instruct the user to connect the user's current device to a device connector such as the device connector 162, and/or to establish a wireless connection between the user's device and the kiosk, so as to establish a communication channel between a processor of the kiosk and the user's device.

The method 200 also comprises scanning the user's current device (step 208). The scanning may occur, for example, after the user's device has been placed into a device intake alcove of the kiosk, and/or after a communication channel has been established between the user's device and a processor of the kiosk. The scanning may comprise scanning the physical structure of the device, which may be completed by a 3D scanner capable of generating a 3D image or model of the user's device. The 3D scanner may be a laser 3D scanner, a projected or structured light 3D scanner, or any other 3D scanner. The physical scan may be used to determine or to verify the type of device submitted by the user, and/or to determine the physical condition of the submitted device (e.g., to identify physical damage to the exterior of the submitted device). The physical scan may also be used to determine an orientation of the device, and/or to identify a port type and/or position of the device. In some embodiments, a 2D scanner may scan a surface of the device, and instructions provided via the user interface of the kiosk may instruct the user to manually rotate the device so that the 2D scanner can scan one or more other surfaces of the device.

The scanning may also comprise an electronic scan of the device, which may be completed by a processor of the kiosk. The electronic scan may be used to determine, for example, which operating system is currently installed on the device, and how recently the operating system was updated; how much memory is provided in the device; the International Mobile Equipment Identity (IMEI) number of the device; whether the device has any contacts, photos, movies, text messages, mobile web applications, apps, usage and/or browsing histories, call logs, voicemails, emails, settings, and device identification numbers, or other personal or pertinent information that would need to be captured and/or transferred to a new device, and if so, the amount of such data (e.g. in megabytes or gigabytes); whether the device is configured for use with the cellular network of a particular manufacturer; and any other useful information. In some embodiments, the electronic scanning of the device may be possible only after the user unlocks the device with a password, or after another access control system of the device is disabled or disengaged. In these embodiments, the user interface may provide instructions to the user to unlock the device, and/or to disable an access control system of the device prior to establishing a communication channel between the processor and the device.

The method 200 comprises looking up or searching, within an online IMEI database, and with the processor and via a wireless transceiver or other communication interface, the IMEI number of the submitted device (step 212). The lookup may be conducted on www.imei.com or using any other suitable online IMEI database. The purpose of the IMEI lookup is to allow the processor to make a determination as to whether the user's device is blacklisted or stolen (step 216). If, during the lookup, the processor receives information indicating that the device is blacklisted or stolen, then the processor may report to the user of the kiosk and/or to an appropriate authority (e.g. via a wireless or other connection to the Internet or another network) that the device is blacklisted or stolen (step 220), and may instruct the user to retrieve the device from the device intake alcove (step 224). As with other steps of the methods described herein, instructions to the user may be displayed to the user via a graphical user interface and/or spoken or otherwise audibly conveyed to the user via a speaker.

If the processor determines, in step 216, that the submitted device is not blacklisted or stolen, then the processor may cause a user interface of the kiosk to display to the user all available new and refurbished devices that are available for purchase and/or exchange (step 228). The display may comprise a list of available devices, a picture of each available device, a price of each available device (which may or may not reflect a credit for a device being exchanged), specifications regarding each available device, and any other pertinent information regarding each available device. Displaying such information beneficially permits a user of the kiosk to compare different available devices. The display may comprise one or more recommendations for a device that is similar to the device submitted by the user, and the recommendations may take into account the available inventory of devices within the kiosk. In some embodiments, the user may be able to navigate among a plurality of screens to gather all of the foregoing information, so that no one screen is overly crowded with information. Such navigation may be accomplished using a user input device to, for example, select an available device for more information about the device. Also in some embodiments, the kiosk may comprise hardware and software necessary to enable a user of the kiosk to utilize the user interface to communicate with a live sales agent, who can answer questions from the user about available new or refurbished devices. In such embodiments, the communications with the live sales agent may be enabled via a cellular connection, a Voice over IP connection, instant messaging, or any other available communication channel.

When the user chooses a device for which to exchange his or her current device (or to purchase without exchanging another device), the user interface may send a signal corresponding to the selection to the processor. The processor receives the device selection signal (step 232). In response to receipt of the device selection signal, the processor may cause an automated storage center of the kiosk to retrieve the selected device from the inventory stored therein, and to deliver and/or connect the selected device to a device configuration module.

The device configuration module, which may comprise or be controlled by the processor, configures the new or refurbished device selected by the user (step 236). The device configuration module may configure the device to match the settings and configuration of the device being submitted by the user, and/or the settings and configuration specified by the user via a user interface of the kiosk. The configuration may include, for example, configuring the device for use with a cellular network of which the user is a customer; copying the user's contacts, photos, movies, text messages, mobile web applications, apps, usage and/or browsing histories, call logs, voicemails, emails, settings, and device identification numbers onto the device; configuring the settings of the device to match the settings of the user-submitted device or based on instructions provided by the user; and otherwise preparing the device for use by the user. In some embodiments, the device configuration module may comprise hardware and software necessary to enable a user of the kiosk to utilize the user interface to communicate with live technical support, whether via a cellular connection, a Voice over IP connection, instant messaging, or any other available communication channel. The live technical support may be configured to transmit commands to the processor of the kiosk, via a wireless transceiver or other communication interface of the kiosk, to cause the processor of the kiosk to take a desired action (or not to take an undesirable action that would otherwise be taken).

Also included in the method 200 is the offering to the user, via a user interface, one or more device accessories and/or a device protection plan (step 240). The accessories may be, for example, headphones or earbuds, device cases, charging cords, cables and/or connectors, screen protectors, camera accessories, and any other available accessories. In some embodiments, one or more of the offered accessories may be or include an app that, if purchased by the user prior to delivery (via the kiosk) to the user of the user's new or refurbished device, will be installed on the device prior to delivery thereof to the user. One or more protection plans may also be offered to the user, the terms and conditions of which, and/or the price of which, may vary based on the particular new or refurbished device selected by the user. In some embodiments, multiple protection plan options may be presented to the user, which may differ in coverage and cost.

The method 200 comprises collecting payment, via a payment center of the kiosk, from the user for any products or services purchased through the kiosk (step 244). The payment center may receive one or more signals from the processor of the kiosk, which one or more signals may comprise information about the price of the products and/or services purchased by the user and/or the amount to be charged to the user for purchased products or services. The payment center may comprise hardware and/or software for receiving cash, credit card, debit card, and/or gift card payments, and/or for receiving bank account information from the user for electronically debiting the user's bank account, and/or for accessing an account held by the user with an operator of the kiosk (e.g., to access any credit previously provided to the user, whether in exchange for a user's previous device or otherwise). The payment center may also accept wireless payments via devices or otherwise. The payment center may utilize any known or available payment method, and, after receiving payment, may transmit one or more signals to the processor to verify that payment has been received.

The method 200 comprises presenting the new or refurbished device to the user, along with any accessories purchased by the user and/or any protection plans purchased by the user (step 248). The presenting may comprise delivering the new or refurbished device, and/or any accessories purchased by the user, to a device delivery alcove of the kiosk, from which the user may retrieve the new or refurbished device and any purchased accessories. The presenting may also comprise printing the terms and conditions of any protection plan purchased by the user, and/or printing user manuals, warranty information, receipts, and any other pertinent information corresponding to the products and/or services purchased and/or utilized by the user. Additionally or alternatively, the presenting may comprise electronically transmitting the terms and conditions of any protection plan purchased by the user, and/or any user manuals, warranty information, receipts, and any other pertinent information corresponding to the products and/or services purchased and/or utilized by the user. The electronically transmitting may utilize a wireless transceiver or any other communications transceiver of the kiosk, and may also utilize information (e.g., an email address) provided by the user via a user interface of the kiosk.

When a user submits his or her device for repair in exchange for another device, as in the method 200, the kiosk may wipe all personal and purchased data from the device and store the submitted device for later pickup by a representative of an operator of the kiosk, who may retrieve any submitted devices, repair them, and, in some embodiments, return them to the kiosk as part of the inventory of the kiosk, to be thereafter available for sale or exchange.

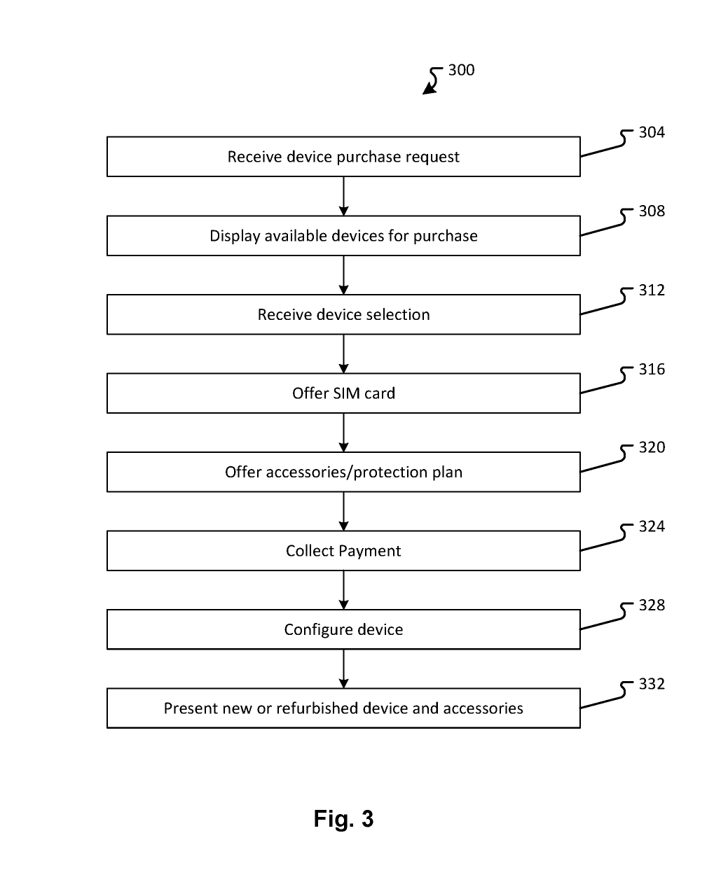

Turning now to FIG. 3, a method 300 of operating a kiosk according to another embodiment of the present disclosure comprises receiving, at a processor, a device purchase request from a user via a user interface of the kiosk (step 304). The device purchase request may be received after the processor causes information about the products and services available through the kiosk to be displayed on the user interface of the kiosk.

The method 300 comprises displaying, via a user interface of the kiosk, available devices for purchase (step 308). The displaying available devices for purchase occurs as a result of instructions or other signals sent by a processor of the kiosk to the user interface, and utilizes information about the available devices for purchase that is stored in a memory of the kiosk. The information displayed may be a list of available devices by brand, model name, and/or price. In some embodiments, the user interface may allow the user to obtain more information about a given available device by clicking on the device in question or otherwise requesting additional information.

When the user, through the user interface, selects an available device for purchase, the user interface may transmit one or more signals to the processor of the kiosk containing information about the device selection. The processor receives the device selection information (step 312), and may transmit one or more signals back to the user interface that cause the user interface to display a confirmation that the device selection has been received.

The processor may also cause the user interface to display information to a user about one or more SIM cards that are available for use with the selected device (step 316). The processor may transmit one or more signals to the user interface about the one or more SIM cards, and/or the processor may cause the user interface to obtain information stored in a memory of the kiosk about the one or more SIM cards. The information displayed to the user may include, for example, information about the wireless carrier(s) with which the SIM cards may be used, the cost of the SIM cards, and the coverage area of the wireless carrier(s) with which the SIM cards may be used.

The processor may further cause the user interface to display information to the user about one or more accessories and/or protection plans available for purchase together with the selected device (step 320). The accessories may be, for example, headphones or earbuds, device cases, charging cords, cables and/or connectors, screen protectors, camera accessories, and any other available accessories. In some embodiments, one or more of the offered accessories may be or include an app that, if purchased by the user, may be installed by the device configuration module on the device prior to delivery thereof to the user. One or more protection plans may also be offered to the user, the terms and conditions of which, and/or the price of which, may vary based on the particular new or refurbished device selected by the user. In some embodiments, multiple protection plan options may be presented to the user, which may differ in coverage and cost.

The method 300 further comprises collecting payment, via a payment center of the kiosk, from the user for the selected device and any additional accessories/protection plan(s) purchased by the user (step 324). The payment center may receive one or more signals from the processor of the kiosk, which one or more signals may comprise information about the price of the products and/or services purchased by the user and/or the amount to be charged to the user for purchased products or services. The payment center may comprise hardware and/or software for receiving cash and/or credit card payments, and/or for receiving bank account information from the user for electronically debiting the user's bank account, and/or for accessing an account of the user with an operator of the kiosk (e.g., to access any credit previously provided to the user, whether in exchange for a user's previous device or otherwise). The payment center may also accept wireless payments via devices or otherwise (e.g., using a Near-Field Communications protocol). The payment center may utilize any known or available payment method, and, after receiving payment, may transmit one or more signals to the processor to verify that payment has been received.

The method 300 comprises configuring the purchased new or refurbished device to match the settings and configuration of a device submitted by a user, and/or to match a user's preferences as provided via the user interface of the kiosk (step 328). The configuring may be done by a device configuration module, which may be controlled by the processor. The configuration may include, for example, configuring the device for use with a cellular network of which the user is a customer; copying the user's contacts, photos, movies, text messages, mobile web applications, apps, usage and/or browsing histories, call logs, voicemails, emails, settings, and device identification numbers onto the device; configuring the settings of the device to match the settings of the user-submitted device or based on instructions provided by the user; and otherwise preparing the device for use by the user.

The method 300 also comprises presenting the new or refurbished device to the user, along with any accessories purchased by the user and/or any protection plans purchased by the user (step 332). The presenting may comprise delivering the new or refurbished device, and/or any accessories purchased by the user, to a device delivery alcove of the kiosk, from which the user may retrieve the new or refurbished device and any purchased accessories. The presenting may also comprise printing the terms and conditions of any protection plan purchased by the user, and/or printing user manuals, warranty information, receipts, and any other pertinent information corresponding to the products and/or services purchased and/or utilized by the user. Additionally or alternatively, the presenting may comprise electronically transmitting, to an email address or other online destination specified by the user, the terms and conditions of any protection plan purchased by the user, and/or any user manuals, warranty information, receipts, and any other pertinent information corresponding to the products and/or services purchased and/or utilized by the user. The electronically transmitting may be accomplished via a wireless transceiver or any other communications transceiver of the kiosk.

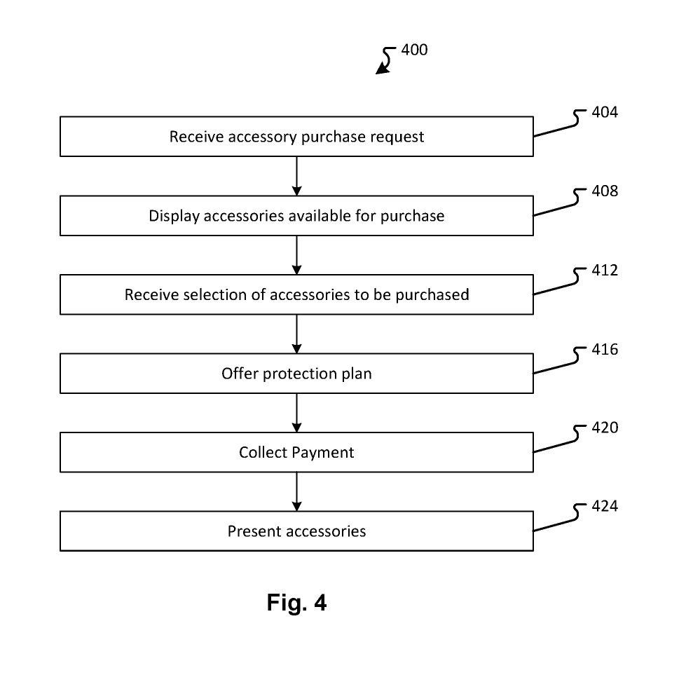

Turning now to FIG. 4, a method 400 of operating a kiosk according to another embodiment of the present disclosure comprises receiving, at a processor, an accessory purchase request from a user via a user interface of the kiosk (step 404). The accessory purchase request may be received after the processor causes information about the products and services available through the kiosk to be displayed on the user interface of the kiosk.

The method 400 comprises displaying, via a user interface of the kiosk, available accessories for purchase (step 408). The displaying available accessories for purchase occurs as a result of instructions or other signals sent by a processor of the kiosk to the user interface, and utilizes information that is stored in a memory of the kiosk about the available devices for purchase. The information displayed may be a list of available accessories by type, brand, model name, and/or price. In some embodiments, the user interface may allow the user to obtain more information about a given accessory by clicking on the accessory in question or otherwise requesting additional information.

When the user, through the user interface, selects an available accessory for purchase, the user interface may transmit one or more signals to the processor of the kiosk containing information about the device selection. The processor receives the accessory selection information (step 412), and may transmit one or more signals back to the user interface that cause the user interface to display a confirmation that the accessory selection has been received.

The processor may further cause the user interface to display information to the user about one or more protection plans available for purchase (step 416). The terms and conditions of the protection plan(s), and/or the price of the protection plan(s), may vary based on the type of device or accessory for which the protection plan is being purchased by the user. In some embodiments, multiple protection plan options, which may differ in coverage and cost, may be presented to the user.

The method 400 further comprises collecting payment from the user for the selected accessories and any protection plan(s) purchased by the user (step 420). The payment may be collected via a payment center of the kiosk. The payment center may receive one or more signals from the processor of the kiosk, which one or more signals may comprise information about the price of the accessories and any protection plans purchased by the user and/or the amount to be charged to the user for purchased accessories and any protection plans. The payment center may comprise hardware and/or software for receiving cash and/or credit card payments, and/or for receiving bank account information from the user for electronically debiting the user's bank account, and/or for accessing an account of the user with an operator of the kiosk (e.g., to access any credit previously provided to the user, whether in exchange for a user's previous device or otherwise). The payment center may also accept wireless payments via devices or otherwise. The payment center may utilize any known or available payment method, and, after receiving payment, may transmit one or more signals to the processor to verify that payment has been received.

The method 400 also comprises presenting the purchased accessories to the user (as well as any protection plans purchased by the user) (step 424). The presenting may comprise delivering the accessories to a device delivery alcove of the kiosk, from which the user may retrieve the purchased accessories. The presenting may also comprise printing the terms and conditions of any protection plan purchased by the user, and/or printing user manuals, warranty information, receipts, and any other pertinent information corresponding to the accessories purchased by the user. Additionally or alternatively, the presenting may comprise electronically transmitting the terms and conditions of any protection plan purchased by the user, and/or any user manuals, warranty information, receipts, and any other pertinent information corresponding to the accessories purchased by the user. The electronically transmitting may utilize a wireless transceiver or any other communications transceiver of the kiosk, and may also utilize information (e.g., an email address or other online destination) provided by the user via a user interface of the kiosk.

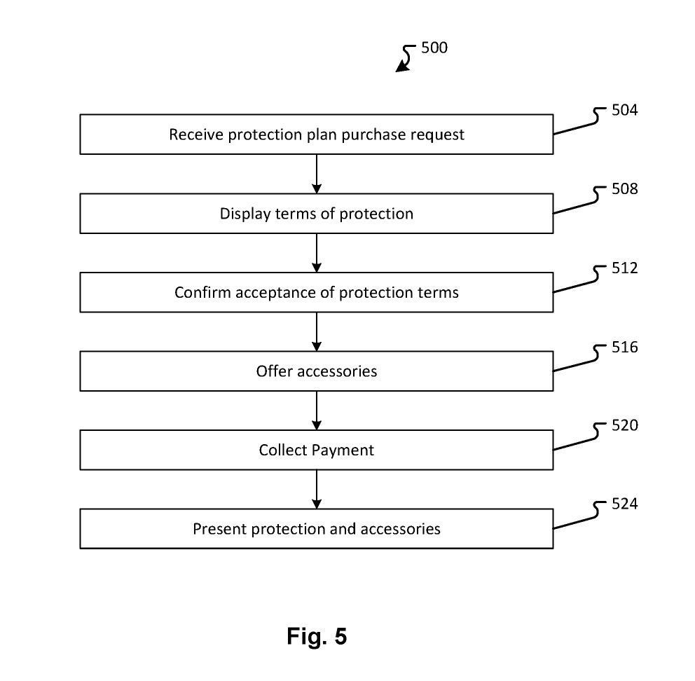

With reference to FIG. 5, a method 500 of operating a kiosk according to another embodiment of the present disclosure comprises receiving, at a processor, a protection plan purchase request from a user via a user interface of the kiosk (step 504). The protection plan purchase request may be received after the processor causes information about the products and services available through the kiosk to be displayed on the user interface of the kiosk.

The method 500 comprises displaying, via a user interface of the kiosk, the terms of one or more protection plans available for purchase (step 508). The displaying the terms of one or more protection plans available for purchase occurs as a result of instructions executed by the processor, which cause the processor to transmit one or more signals to the user interface that cause the user interface to display the information. The displaying may utilize information about available protection plans that is stored in a memory of the kiosk. In some embodiments, the user interface may allow the user to obtain more information about a given protection plan by clicking on the protection plan in question or otherwise requesting additional information. Also in some embodiments, the processor may cause the user interface to display a request for information from the user about a device to be protected with the desired protection plan. In such embodiments, the processor may receive the requested information, and may cause the user interface to display information about one or more specific protection plans (or to display information about the price of the protection plan) that is tailored based on the requested information.

When the user, through the user interface, confirms that he or she would like to purchase a protection plan, the user interface may transmit one or more signals to the processor of the kiosk indicating the same. In return, the processor may transmit one or more signals to the user interface that cause the user interface to require that the user confirm acceptance of the terms of the protection plan in order to proceed with the purchase (step 512). The processor may then receive one or more signals from the user interface indicating whether the user has confirmed acceptance of the protection plan terms.

The processor may further cause the user interface to display information to the user about one or more accessories available for purchase (step 516). The displaying available accessories for purchase occurs as a result of instructions or other signals sent by a processor of the kiosk to the user interface, and utilizes information stored in a memory of the kiosk about the available accessories for purchase. The information displayed may be a list of available accessories by type, brand, model name, and/or price. In some embodiments, the user interface may allow the user to obtain more information about a given available accessory by clicking on the accessory in question or otherwise requesting additional information.

The method 500 further comprises collecting payment, via a payment center of the kiosk, from the user for the selected protection plan and any accessories purchased by the user (step 520). The payment center may receive one or more signals from the processor of the kiosk, which one or more signals may comprise information about the price of the protection plan and any accessories purchased by the user and/or the amount to be charged to the user for purchased protection plan and any accessories. The payment center may comprise hardware and/or software for receiving cash and/or credit card payments, and/or for receiving bank account information from the user for electronically debiting the user's bank account, and/or for accessing an account of the user with an operator of the kiosk (e.g., to access any credit previously provided to the user, whether in exchange for a user's previous device or otherwise). The payment center may also accept wireless payments via devices or otherwise. The payment center may utilize any known or available payment method, and, after receiving payment, may transmit one or more signals to the processor to verify that payment has been received.

The method 500 also comprises presenting the purchased protection plan (as well as any purchased accessories) to the user (step 524). The presenting may comprise delivering the accessories to a device delivery alcove of the kiosk, from which the user may retrieve the purchased accessories. The presenting may also comprise printing the terms and conditions of any protection plan purchased by the user, and/or printing user manuals, warranty information, receipts, and any other pertinent information corresponding to the accessories purchased by the user. Additionally or alternatively, the presenting may comprise electronically transmitting the terms and conditions of any protection plan purchased by the user, and/or any user manuals, warranty information, receipts, and any other pertinent information corresponding to the accessories purchased by the user. The electronically transmitting may utilize a wireless transceiver or any other communications transceiver of the kiosk, and may also utilize information (e.g., an email address) provided by the user via a user interface of the kiosk.

A number of variations and modifications of the foregoing disclosure can be used. It would be possible to provide for some features of the disclosure without providing others.

Although the present disclosure describes components and functions implemented in the aspects, embodiments, and/or configurations with reference to particular standards and protocols, the aspects, embodiments, and/or configurations are not limited to such standards and protocols. Other similar standards and protocols not mentioned herein are in existence and are considered to be included in the present disclosure. Moreover, the standards and protocols mentioned herein and other similar standards and protocols not mentioned herein are periodically superseded by faster or more effective equivalents having essentially the same functions. Such replacement standards and protocols having the same functions are considered equivalents included in the present disclosure.

The present disclosure, in various aspects, embodiments, and/or configurations, includes components, methods, processes, systems and/or apparatus substantially as depicted and described herein, including various aspects, embodiments, configurations embodiments, subcombinations, and/or subsets thereof. Those of skill in the art will understand how to make and use the disclosed aspects, embodiments, and/or configurations after understanding the present disclosure. The present disclosure, in various aspects, embodiments, and/or configurations, includes providing devices and processes in the absence of items not depicted and/or described herein or in various aspects, embodiments, and/or configurations hereof, including in the absence of such items as may have been used in previous devices or processes, e.g., for improving performance, achieving ease and/or reducing cost of implementation.

The foregoing discussion has been presented for purposes of illustration and description. The foregoing is not intended to limit the disclosure to the form or forms disclosed herein. In the foregoing Detailed Description, for example, various features of the disclosure are grouped together in one or more aspects, embodiments, and/or configurations for the purpose of streamlining the disclosure. The features of the aspects, embodiments, and/or configurations of the disclosure may be combined in alternate aspects, embodiments, and/or configurations other than those discussed above. This method of disclosure is not to be interpreted as reflecting an intention that the claims require more features than are expressly recited in each claim. Rather, as the following claims reflect, inventive aspects lie in less than all features of a single foregoing disclosed aspect, embodiment, and/or configuration. Thus, the following claims are hereby incorporated into this Detailed Description, with each claim standing on its own as a separate preferred embodiment of the disclosure.

Moreover, though the description has included description of one or more aspects, embodiments, and/or configurations and certain variations and modifications, other variations, combinations, and modifications are within the scope of the disclosure, e.g., as may be within the skill and knowledge of those in the art, after understanding the present disclosure. It is intended to obtain rights which include alternative aspects, embodiments, and/or configurations to the extent permitted, including alternate, interchangeable and/or equivalent structures, functions, ranges or steps to those claimed, whether or not such alternate, interchangeable and/or equivalent structures, functions, ranges or steps are disclosed herein, and without intending to publicly dedicate any patentable subject matter.

Examples of the processors as described herein may include, but are not limited to, at least one of Qualcomm® Snapdragon® 800 and 801, Qualcomm® Snapdragon® 610 and 615 with 4G LTE Integration and 64-bit computing, Apple® A11, A10, A9, A8, or A7 processor with 64-bit architecture, Apple® M11, M10, M9, M8, or M7 motion coprocessors, Samsung® Exynos® series, the Intel® Core™ family of processors, the Intel® Xeon® family of processors, the Intel® Atom™ family of processors, the Intel Itanium® family of processors, Intel® Core® i5-4670K and i7-4770K 22 nm Haswell, Intel® Core® i5-3570K 22 nm Ivy Bridge, the AMD® FX™ family of processors, AMD® FX-4300, FX-6300, and FX-8350 32 nm Vishera, AMD® Kaveri processors, Texas Instruments® Jacinto C6000™ automotive infotainment processors, Texas Instruments® OMAP™ automotive-grade mobile processors, ARM® Cortex™-M processors, and ARM® Cortex-A and ^{ARM}926EJ-S™ processors. A processor as disclosed herein may perform computational functions using any known or future-developed standard, instruction set, libraries, and/or architecture.

What is claimed is:

1. A kiosk comprising:
a device intake alcove;
a device delivery alcove;
an automated storage center storing a plurality of inventory items and comprising an automated system for selectively retrieving a selected one of the plurality of inventory items;
a user interface comprising a display screen and a user input device;
a payment center;
a processor; and
a memory storing instructions for execution by the processor that, when executed by the processor, cause the processor to:
download user information from a submitted device positioned in the device intake alcove;
cause the automated system to retrieve a selected device from the plurality of inventory items;
upload the user information to the selected device; and
cause the automated system to place the selected device in the device delivery alcove.

2. The kiosk of claim 1, wherein the device intake alcove comprises a 3D scanner, and the memory stores additional instructions for execution by the processor that, when executed by the processor, cause the processor to:
cause the 3D scanner to scan the submitted device and generate a 3D image of the submitted device;
analyze the 3D image of the submitted device; and
identify, based on the analysis, physical damage to the submitted device.

3. The kiosk of claim 1, wherein the device intake alcove comprises a device connector, and the memory stores additional instructions for execution by the processor that, when executed by the processor, cause the processor to:
cause the display screen to display instructions for connecting the device connector to the submitted device; and
electronically scan the submitted device to obtain device information about the submitted device.

4. The kiosk of claim 3, wherein the device information comprises an identification number of the device, and the memory stores additional instructions for execution by the processor that, when executed by the processor, cause the processor to:
access, via a communication interface, a database of device identification numbers;
search the database using the identification number of the device to obtain search results; and
determine, based on the search results, whether the submitted device is blacklisted or stolen.

5. The kiosk of claim 1, wherein the memory stores device inventory information comprising information about a plurality of devices available for purchase or exchange from the kiosk; and further wherein the memory stores additional instructions for execution by the processor that, when executed by the processor, cause the processor to:
cause the display screen to display at least some of the device inventory information; and
receive, via the user input device, a signal identifying one of the plurality of devices selected for purchase or exchange by a user of the kiosk.

6. The kiosk of claim 1, wherein the memory stores accessory inventory information comprising information about a plurality of accessories available for purchase from the kiosk; and further wherein the memory stores additional instructions for execution by the processor that, when executed by the processor, cause the processor to:
cause the display screen to display at least some of the accessory inventory information; and
cause the display screen to solicit a user selection related to the displayed accessory inventory information.

7. The kiosk of claim 1, wherein the memory stores terms and conditions of at least one protection plan available for purchase from the kiosk; and further wherein the memory stores additional instructions for execution by the processor that, when executed by the processor, cause the processor to:
cause the display screen to display the terms and conditions of at least one protection plan available for purchase from the kiosk; and
cause the display screen to solicit a user selection related to the displayed terms and conditions.

8. The kiosk of claim 1, wherein the memory stores additional instructions for execution by the processor that, when executed by the processor, cause the processor to:
transmit a signal to the payment center, the signal corresponding to an amount of money to be collected from a user; and
receive a confirmation signal from the payment center, the confirmation signal indicating that the amount of money has been collected.

9. The kiosk of claim 1, wherein the user interface is a touchscreen.

10. The kiosk of claim 1, further comprising a communication interface that enables a user of the kiosk to send and receive live communications from the user interface.

11. A device exchange and data transfer kiosk comprising:
an automated storage center for storing an inventory comprising multiple items, the automated storage center comprising an automated system for selectively retrieving a selected inventory item from among the multiple items in inventory;
a user interface comprising a touchscreen;
a payment center;
a wireless transceiver;
a processor;
a device intake module, the device intake module comprising at least one of a 3D scanner and a device connector; and
a device configuration module comprising instructions for execution by the processor that, when executed by the processor, cause the processor to:
obtain data and information from a first device; and
configure a second device based on the obtained data and information.

12. The device exchange and data transfer kiosk of claim 11, wherein the first device utilizes a different operating system than the second device.

13. The device exchange and data transfer kiosk of claim 12, wherein the configuring comprises converting at least some of the obtained data and information from a first format into a second format.

14. The device exchange and data transfer kiosk of claim 13, wherein the obtained data and information comprises at least one of user contacts, user photos, movies, text messages, mobile web applications, apps, call logs, voicemails, emails, usage histories, browsing histories, and settings.

15. The device exchange and data transfer kiosk of claim 11, wherein the obtaining and configuring are completed in ten minutes or less.

16. A kiosk for exchanging devices, comprising:
a storage area comprising an inventory of devices;
a touchscreen user interface configured to display information about products and services available through the kiosk and to receive user selections;
a device intake alcove;
a device intake module comprising an imaging device;
a processor;
a communication interface for establishing electronic communications between the processor and a submitted device;
a device configuration module for configuring a purchased device; and
a device delivery alcove.

17. The kiosk of claim 16, wherein the device intake module further comprises instructions for execution by the processor that, when executed by the processor, cause the processor to:
cause the touchscreen user interface to display instructions for placing the submitted device into the device intake alcove;
cause the imaging device to capture an image of the submitted device;
analyze the image; and
based on the analysis, identify physical damage to the submitted device.

18. The kiosk of claim 16, wherein the device intake module further comprises instructions for execution by the processor that, when executed by the processor, cause the processor to:
cause the touchscreen user interface to display instructions for establishing a communication channel between the submitted device and the processor;
obtain a unique device identification number corresponding to the submitted device via the communication channel;
download user information from the submitted device; and
cause the user information on the submitted device to be erased.

19. The kiosk of claim 18, wherein the device configuration module further comprises instructions for execution by the processor that, when executed by the processor, cause the processor to upload the user information to a purchased device from among the inventory of devices.

20. The kiosk of claim 16, further comprising an automated inventory management system configured to retrieve a selected device from among the inventory of devices, position the selected device for configuration by the device configuration module, and deliver the selected device to the device delivery alcove.
